(19) United States
(12) Patent Application Publication
(10) Pub. No.: US 2020/0202050 A1
(43) Pub. Date: Jun. 25, 2020

(54) OIL & GAS LAYOUT MODULE

(71) Applicant: FutureOn, LLC, Houston, TX (US)

(72) Inventors: Darrell Knight, Atlanta, GA (US); Jostein Lien, Oslo (NO); Olivier Charles Robert Chatry, Oslo (NO); Jon-Andr Christensen Babsvik, Fredrikstad (NO); Olav Andre Sylthe, Oslo (NO); Osman Keskin, Oslo (NO)

(73) Assignee: FutureOn, LLC, Houston, TX (US)

(21) Appl. No.: 16/723,705

(22) Filed: Dec. 20, 2019

Related U.S. Application Data
(60) Provisional application No. 62/782,692, filed on Dec. 20, 2018.

(51) Int. Cl. G06F 30/18

(52) U.S. Cl. CPC G06F 30/18; G06F 2113/14

(57) ABSTRACT

An oil & gas pipe layout design module configured to determine a layout of pipe based on minimum bend range, design circles, and locations of drilling assets on a subsea floor.

### PRIORITY

This application claims priority of U.S. Provisional Patent Application U.S. Ser. No. 62/782,692 filed Dec. 20, 2018 entitled FieldAp Future Vision, the teachings of which are incorporated herein by reference.

### TECHNICAL FIELD

The present subject matter relates to an oil & gas pipe layout design on a subsea floor.

### BRIEF DESCRIPTION OF THE DRAWINGS

The drawing figures depict one or more implementations, by way of example only, not by way of limitations. In the figures, like reference numerals refer to the same or similar elements.

FIG. 1 is an illustration of an open data platform;

FIG. 2 illustrates a visualization layer providing for near real time presentation of asset locations;

FIG. 3 shows sensor/IoT data readings linked to a digital asset;

FIG. 4 illustrates pumps and public metadata;

FIG. 5 illustrates a Maintenance Status module;

FIG. 6 illustrates a single asset in 3D mode;

FIG. 7 illustrates a full field network topology;

FIG. 8 illustrates well topology;

FIG. 9 illustrates well data;

FIG. 10 illustrates all project data is only stored in one instance;

FIG. 11 illustrates a drilling radius in 2D and 3D with a circular representation;

FIG. 12 illustrates a transactional ledger;

FIG. 13 illustrates bend radius circles when a pipe or connection needs to have a bend;

FIG. 14 illustrates sample settings;

FIG. 15 illustrates deviation circle display;

FIG. 16 illustrates a 3D scene of a topside, subsea, and sub terrain;

FIG. 17 illustrates an example of using multiple cameras;

FIG. 18 illustrates an entire screen making assets and connections(pipes) too small to see;

FIG. 19 illustrates a large field layout shown in contracted form in 2D;

FIG. 20 illustrates a large field layout shown in contracted form in 3D;

FIG. 21 illustrates an overview of all assets/lines/connections;

FIG. 22 illustrates a screenshot of a customer engineering design;

FIG. 23 illustrates P&ID (Piping and Instrumentation) diagrams of assets;

FIG. 24 illustrates a server-side rendition of a high res screen shot;

FIG. 25 illustrates a 3D view of the globe as a Google Earth;

FIG. 26 illustrates an example is a user interface (UI) integration;

FIG. 27 illustrates a stats dashboard;

FIG. 28 illustrates Statistics Dashboard module;

FIG. 29 illustrates a Field Layout with related information;

FIG. 30 illustrates informational views adapted to the screen; and

FIG. 31 illustrates relevant content displayed in the context of a smaller screen.

### DETAILED DESCRIPTION

In an example, this disclosure includes an oil & gas pipe layout design module configured to determine a layout of pipe based on minimum bend range, design circles, and locations of drilling assets on a subsea floor.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

The orientations of the eyewear device, associated components and any complete devices incorporating an eye tracker and camera such as shown in any of the drawings, are given by way of example only, for illustration and discussion purposes. In operation for a particular variable optical processing application, the eyewear device may be oriented in any other direction suitable to the particular application of the eyewear device, for example up, down, sideways, or any other orientation. Also, to the extent used herein, any directional term, such as front, rear, inwards, outwards, towards, left, right, lateral, longitudinal, up, down, upper, lower, top, bottom and side, are used by way of example only, and are not limiting as to direction or orientation of any optic or component of an optic constructed as otherwise described herein.

Open Standards/Open Platform/Data Interchange

The software vendors in the oil and gas (O&G) industry have all traditionally been delivering expert systems on premise with their own proprietary formats for a singular vertical. This disclosure includes a platform stack as a generic vendor neutral platform that advocates/documents “open standards for the interchange of information” in O&G.

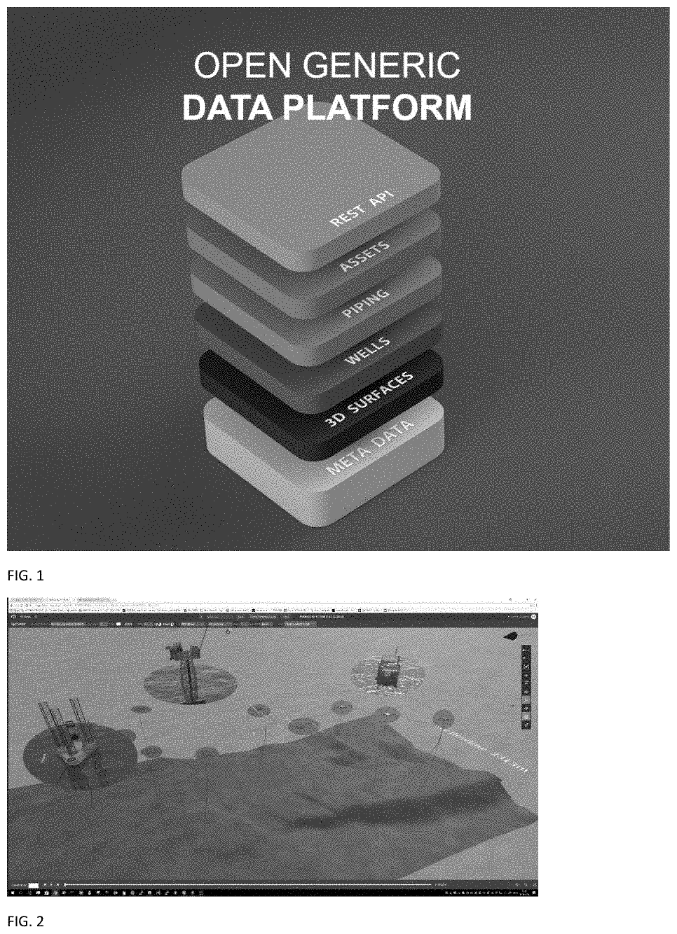

By making vertical integrations/connectors for our platform together with the expert system SW providers be it drilling, simulations etc. we liberate and harness these data from their proprietary silos, store them within the confines of the platform and make them universal available for future “value add” data operations e.g. Machine Leaning, and analytics. Our platform stack depicted in FIG. 1 is designed for this, with a general network topology already today Assets (DAIM), Piping, Wells, Surfaces (2D and 3D), and MetaData/Attributes that are all easily bi-directionally accessible though our API Visualization/Presentation Layer.

With the ability to programmatically create, modify, delete or animate any visual represented asset and/or connection, the Visualization layer in the stack provides direct Field Layout creation and modification through the API.

Furthermore, by providing a “Visual Context”, our visualization/display layer brings great informational value as e.g. contextual placeholders for the presentation of operational data such as, but not limited to; sensor data, maintenance information, linking to external systems for information retrieval (documents, pictures, handbooks, training manuals, or any other queries).

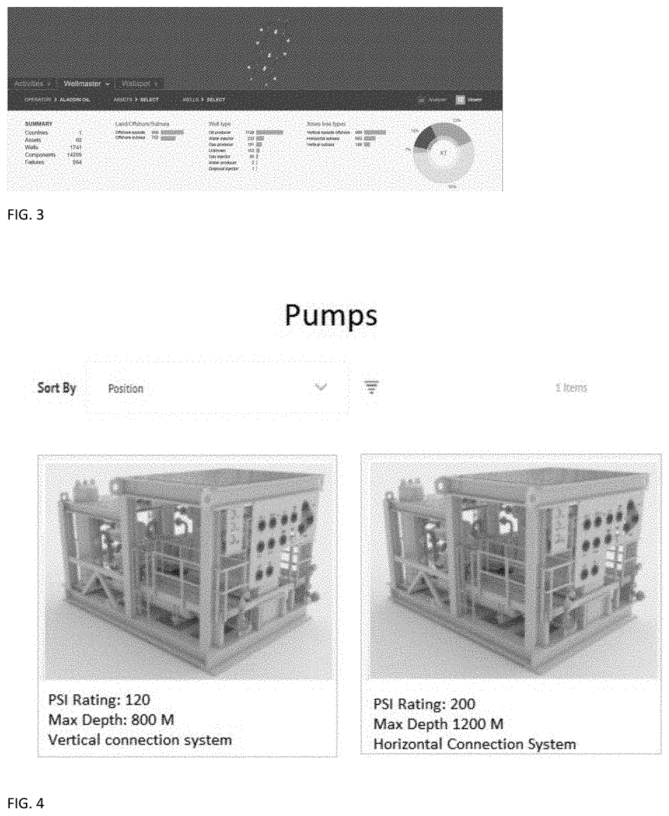

Now, with the introduction of real world coordinates this visualization layer provides for near real time presentation of asset locations e.g. ship positions, as shown in FIG. 2. For example, it can present attached sensor/IoT data readings linked to a digital asset when clicked upon making the values and information be in context, as shown in FIG. 3. Preferably also linked with a module tab with an embedded KPI dashboard.

Digital Asset Information Module (DAIM)

With a gander on BIM (Building Information Modeling) and the idea behind generating more of an asset store, this disclosure provides for the use of assets with the metadata definition capabilities exposed to a broader audience and allow for vendors and existing clients to define more information about their assets. This disclosure also addresses the possibility of two sets of metadata classifications along the lines of private and public. As a use case scenario, it is certainly attractive for operators of suppliers such as OneSubsea and Aker Solution publishes a set of open metadata for their equipment (assets).

As an example of pumps shown in FIG. 4 and public metadata, the various providers list their subsea pumps with us with metadata information such as standard operational pressure, max depth, max throughput, and so on.

Then imagine e.g. Statoil as the operator” doing a search in the asset library for pumps with certain characteristics e.g. operating depth and a max throughput and possible equipment matches would be listed in FieldAP. The operator would then select an Aker pump in one subproject version and run a set of flow assurance test on it, and then compare with an OneSubsea pump in the other sub-project. Based on the flow assurance results combined with cost values and delivery time results they can then make a qualification of the CAPEX/OPEX cost of the various options. That is just one applicable scenario. Other parameters could be production time, regional availability. Again, this is conjecture, but it is what BIM offers.

FieldTwin aka Digital Twin

Our digital assets are typically to simplified for a full-blown Digital Twin model hence we can introduce another moniker for this e.g. “FieldTwin”. This is our asset representation in 2D and 3D. Yes, they are simplified, but the dimensions are correctly represented and all essential parts e.g. pumps/valves/connection systems will be displayed. And hence they serve as anchor points for further information retrieval from corporate back end systems.

This could be Sensor/IoT readings display, or a click event can trigger a relevant refresh of a “Maintenance Status”-module showing e.g. fatigue information. See concept rendering in FIG. 5 on how 4Subea envisioned this.

You could even contemplate a scenario where you query a connected cloud service e.g. “WellSpot” connected to FieldAP in this case for queries such as “Show me all wells that require maintenance based on specific characteristics/threshold settings.

Or we can link this also through partner integrations, so KognifAi from Kongsberg can be launched based on click on high level attention notice in FieldAP.

Single Asset Viewing with streaming (LOD) support

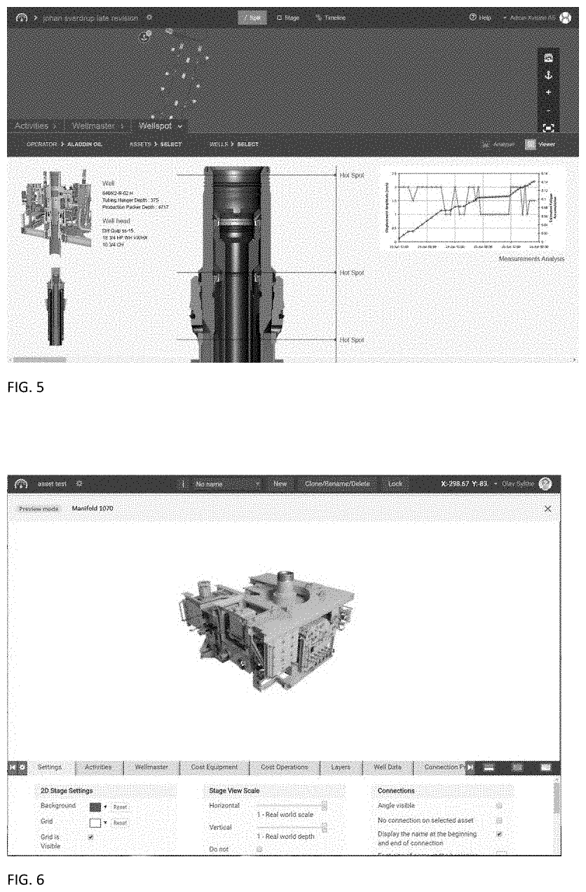

Another scenario we could envision for FieldTwin would be to double click on a single asset in 3D mode, such as shown in FIG. 6, and we would then switch to a single model view and invoke viewing of higher LOD's (Level of Detail). E.g. since we are only viewing a single asset in 3D and not the entire field, we can allow for a much higher level of detail with a much higher poly count and thus approach more of the “Digital Twin” asset representation that the high-end systems do today. This view as represented in a high-quality single asset “FieldTwin” view can then be populated with much more granular asset state/quality information coming from a suitable partner platform.

Having all assets also represented with say 4 levels of LOD could be useful if we get to the point where we can invoke server-side rendering of 3D scenes for glossy presentation purposes.

This single asset view could also be useful as a “Asset Configuration” mode e.g. if we support models built by sub-assembly parts that can be turned on or off e.g. mudmats, trawl protection and so on.

We could even use this view as a launching point for viewing 2D representation or the layout for the asset internal routing setup or P&ID diagrams if you will.

Network Topology

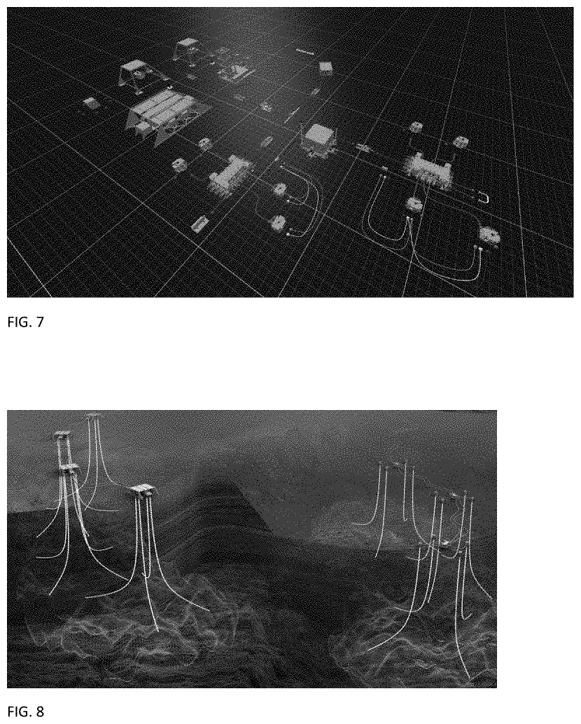

Today the ability exists to retrieve all connections (Piping/Umbilical's etc.) with associated metadata. In other words, if the design is done right we have a full field network topology, as shown in FIG. 7, with connections and assets that can hold any and all required metadata so that a number of operations can be done with the data such as and not limited to; pipe simulations, flow assurance, shortest path/routing, length and costing to mention a few capabilities.

In the future we need to further promote this ability as to attract developers that could use this information for when they bring their expert tools to the cloud in the form of simulations, analytics or calculations as a service.

This can be through the API or provide an open standard that we promote for input and output of this data. It would also be useful if we can easily provide query capabilities for our users on all field data, so they could send queries such as;

How many oil production pipes in steel with heating and insulation do we have deployed?

How many of these are in use in Tyrihans?

What are their names, lengths and location?

Well Topology

Referring to FIG. 8, the same approach should be considered for the well data. Today we support various input formats such as Haliburton Compass, but we should probably aim to define some open source standards here as well as we learn more about the drilling topic and offer up opportunities for data exchange with other drilling specialist platform.

E.g. what value could we bring to the market when integration with the specialist drilling tools outside visualizing the well paths. Can we populate more data in a well information model that can be useful? Should we read in and make available all the data that the Norwegian Petroleum Directorate have available online today by default, so it can be queried? See overview of their data below:

| 2. Raw data | | 10 |
|---|---|---|
| | 2.1. Well-log data | 10 |
| | 2.2. Core data | 11 |
| | 2.3. Geochemical data | 12 |
| | 2.4. Wellbore seismic data | 12 |
| | 2.5. Mudlog data | 13 |
| | 2.6. Wellpath data | 13 |
| 3. Other non-interpreted data | | 14 |
| | 3.1. Well composite log | 14 |
| | 3.2. Additional composited data (petrophysical composite) | 16 |
| | 3.3. Wellpath (or welltrack) data | 16 |
| | 3.4. Core data | 17 |
| | 3.5. Processed wellbore seismic data | 18 |
| 4. Interpreted data | | 19 |
| | 4.1. Petrophysical interpretations | 19 |
| | 4.2. Formation pressure data | 20 |

Outside of that we have had requests for changing information such as the location of top hole and downhole programmatically. Working with 3rd party SW developers within this vertical and providing a rich API for well path and data manipulation would therefore be valuable. A first step here would be to see how we could maybe work with Pro WellPlan or others.

Surface/Information Layer Topology

Formalize a data exchange model for 2D/3D layers used in field layout/design/representation. At the moment static 2D images may offer limited value, but with the idea in mind that bathymetry and reservoir data as 3D surface models could be easily be bidirectional exchanged here it would bring value to the market as an open defined standard.

Recent support for HPCT contour plots (Hydrocarbon Pore Column Thickness) and probably similar other representative data also brings great value here. Screenshot of an HPCT 2D view is shown in FIG. 9.

If we consider that the X,Y,Z data represented with that with the Y axis signifying coloring as a depth factor, this format could possible be expanded to represent color as it would for LIDAR data with return values in RGB color ranges.

Platform/Cloud Agnostic

With the ongoing architecture changes to remove Firebase dependencies initially to support regional deployment for data storage privacy rules and regulations, we will obtain a new abstraction layer that allows us or our clients to use their database of choice be it SQL Server, NoSQL, etc. The development of this is now ongoing and will be available probably around the end of Q2 this year.

With this dependency gone we are now free to deploy fully on Amazon, Google, Azure or even other Cloud infrastructures. Even “On-Prem” deployments will be possible but should be avoided on general principle due to the inherent support overhead.

Cross-Instance Data Subscription Services

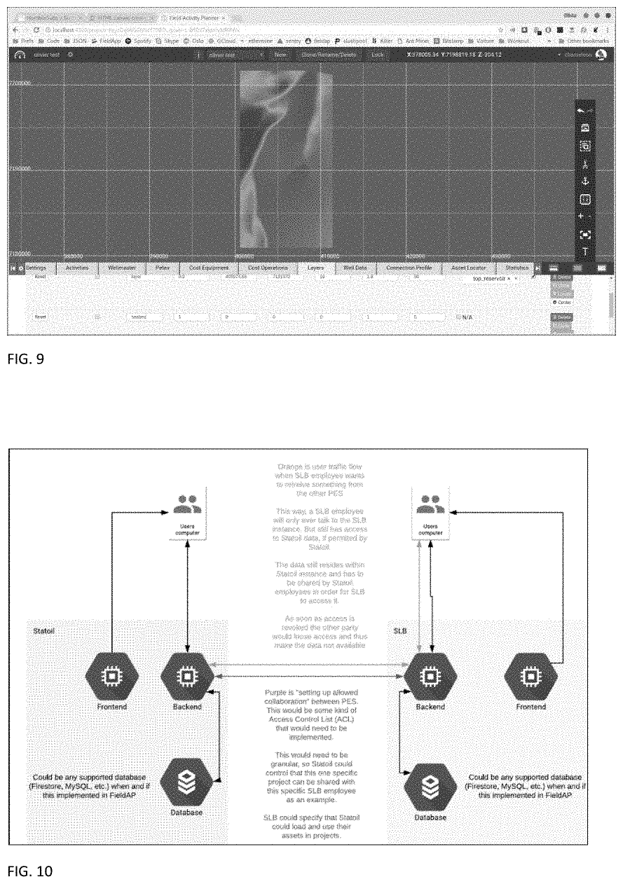

A new architecture could possible also allow us to envision the possibility of “Project Collaboration” without moving data between servers or setting up a dedicated collaboration instance, but instead providing cross instance direct data access as a service. E.g. OSS/SS7 work together on a designated collaboration project, but all project data is only stored in one instance, as shown in FIG. 10.

Project Planning/Activities

With the introduction to a real-world coordinate system the opportunity presents itself to add several new benefits or features if you will with respect to logistics, cost calculations and improved planning capabilities for the “Activity Module”. This module will see more use going forward thanks to especially McDermott. We also have the opportunity to approach Kvaerner ASA as they see marine installations as one of their focus areas going forward. Possible future capabilities could be:

Port Data Base and Ship Registry

Add a database or list of the most common oil related ports to the system so users can select from this list when adding ports to the system. E.g. the user selects Stavanger from a list and the port coordinates are pre-populated so when they plan a trip to an oil field or an asset we can automatically provide the distance. There are also online databases here that we can tap into such as sea-distances.org or the marine traffic database.

With customers such as McDermott and Subsea 7 adding their vessels to “DAIM” (read: Digital Asset Information Management) they will typically add characteristics such as vessel speed and load capacity as metadata. Also, there are ship broker databases available that also have these general capabilities listed. Considering such an tie in with either self-registered data or online data availability a user can in the activity planning be presented with a list of available vessels for a specific date range in a specific port and based on the entered load or other parameters then by providing the destination oil field or asset (Rig or similar) the distance is calculated and presented along with an average calculated day rate directly in the activity planner as one example. E.g. automated population of trip time and estimated cost based on the day rate.

The marine traffic database also has an API allowing us to retrieve and present a layer of all this information. We can then plot these vessels in FieldAP if we look at this from an operational scenario. The same database also has registered data on vessel name, owners, average speed, and load capacity.

Weather Data

For marine operations planning we can consider combining online metrology database such as Ocean4Cast, openocean.fr or similar. Based on route coordinates and data ranges for a marine operation a request can be made to calculate what the expected travel time can be based on 50 years of metrology data for expected weather, wave height, currents etc. So, if you are running a marine operation in the North Sea in October vs June you can expect the sailing time to be different as one example. Accumulation of historical data for the users completed marine operation would also be utilized for new project planning.

Smart Activity Assignment

Today the setting up of activities within the system is somewhat of a manual an onerous process. In the future this can be made simpler by offering a list of the most common tasks for to select from so if a vessel is in port we have mobilizing, and transport to field as options.

When a vessel arrives near an asset or a rig arrives options are available for installation of wellhead, drilling, completion, well testing etc. Length of activities could also have a set default based on averages.

A rig would then also typically move to the next well so maybe also have a way to list a set of natural next destinations and activities. Vessels could even act so they could be dropped onto other assets and that would be a new destination automatically.

Safety Zones

We have always talked about safety zones, but now with real world coordinates, metadata in place and a DAIM future strategy we can make safety zone a default attribute and also visualize this in 2D and 3D with a circular representation either toggled on/off or just when we have a collision.

Drilling Zones

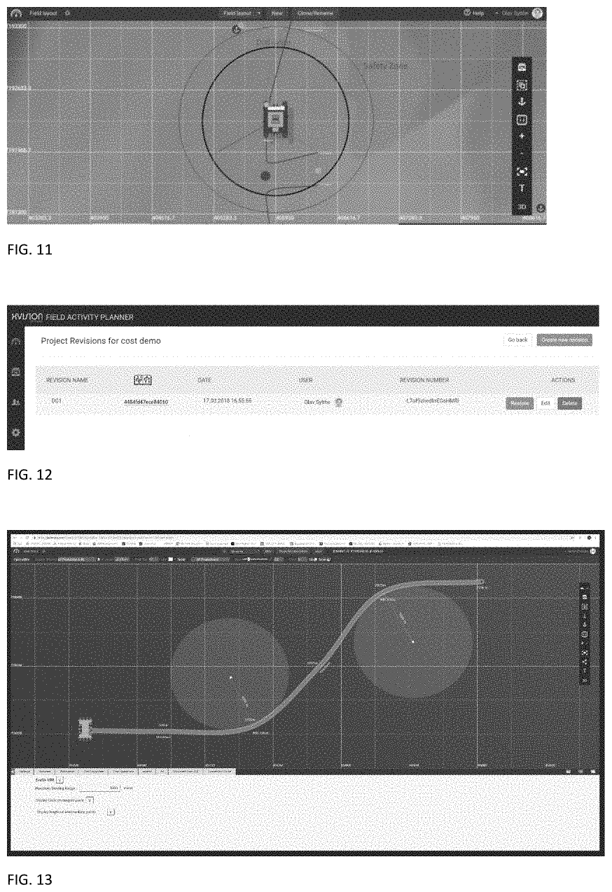

As for Safety zones, drilling radius in 2D and 3D with a circular representation either toggled on/off can easily be visualized, as shown in FIG. 11.

The drilling radius have a great impact on the marine operation planning as that coupled with the anchor/mooring lines determines the location/placement of the rig. And moving these around is a very complex operation that benefits from visualization to ensure that the GANNT chart is realistic and doable.

Collaboration Server

As the industry changes to be more competitive we see more and more alliance opportunities where traditional competitors now cooperate and do joint bids on work where they leverage their field discipline specialties. Examples would be SLB/SS7, Aker/S7, Aker/Saipem, McDermott/BHGE etc. We also see the need for operators to share field designs with the EPC companies e.g. Statoil/OneSubsea as a recent example, where we will have to do extra work in manual project transfers.

Project Based Collaboration

If we are forward thinking we can envision here an approach that we can control and profit from. Enter Field Activity Planner Project Space. Users can go online and create a project-based instance for FieldAP that is e.g. billed monthly and will only exist for the duration of the project. As a use case let us say that we will here consider that SS7/Aker will do a project with Statoil.

Aker instigates the creation of a “Project Space” instance and selects their users from their user list that should have access to this instance, and then selects add collaborators. This sends an invite to the SS7 admin that can then similar add their users. We then automatically spin up a new dedicated instance (by this time that process is fully automated). Both Aker/SS7 also have the option to have their private asset libraries available in the project space as well. We can then also allow for users to transfer a project over to the project space server so people have a starting point and likewise when their collaboration server project is at an end they can choose to transfer projects back, so we will need a server to server project transfer capability.

With the Platform Stack of FIG. 10 for Cross Instance data services in mind this can be done much better and more efficient.

As an example, SS7 starts the design, then invites OSS to collaborate. The project will show up in the OSS instance as a collaboration project, but the data will all be read from the SS7 instance or vice versa. And this could be used right now with Statoil/OSS as we had to manually move a project from the Statoil private instance to OneSubsea private instance.

From a big picture perspective, they could likewise invite a customer in to view/work on it in the same manner e.g. an operator such as Statoil. Or if we turn this on the head and Statoil starts with a layout/design holding bathymetry/reservoir data and maybe default important asset placement locations.

Statoil would then invite in their EPC vendors such as OneSubsea, Aker Solution, Subsea 7, McDermott, Saipem etc. These vendors would then work on their various proposals to Statoil with all the data being available for Statoil to any time, but the EPC vendors would have granular control over what data from their instance with respect to costing and maybe attributes that would show up for Statoil.

We would probably make an option available for cloning so a “local” copy can be made at end of project as an example but respecting all granularity for user right and data share settings.

Value Chain Collaboration

At some point we can also envision them inviting in Statoil to view their projects or possibly transfer their proposal project direct to the Statoil Server with maybe several proposed field layouts and top-level costing that Statoil can then look at in detail.

Or using the cross-data subscription service model Statoil would then pick a vendor and then using that layout/design they can then maybe use the same vendor for the Marine Installation or again share that field out to companies who offer the marine installation services e.g. McDermott or Kvaerner.

After installation the project design layout is updated with the real-world engineering data where relevant e.g. importing connection profiles back for piping etc. This can design can then be used in the future for maintenance operations planning or to as a visual operation dashboard for querying operational data from sensors or maintenance systems aka FieldTwin.

And when it is time to decommission the field the planning for Plug & Abandonment can be done using the same dataset and be collaboratively shared to the decom vendors for their planning.

Digital Audit Trail (aka Blockchain)

Considering that with a collaboration server offering an audit trail would be an important feature, but this also holds true for regular dedicated private instance. As our platform hopefully becomes more central to every day usage and with new compliance rules coming into effect we will need to step beyond logging and offer a comprehensive audit trail initially for only the more important operations and/or transactions such as CRUD (Create, Read, Update, Delete).

This can be a record of who, when, where and what e.g. field created, deleted, transferred, modified, server cost calculation, simulation run, and so on. Typically we would just add an “I” nformation icon to each project so we would list all operations performed of any significance. By doing this we can also capitalize on all the blockchain “hype” and add support for a transactional ledger, as shown in FIG. 12.

The above-mentioned functionality can be implemented through the following supported project from The Linux Foundation.

https://www.hyperledger.org/projects/sawtooth

With reference to the collaboration server this kind of transactional ledger would certainly add value with respect to cross company compliance and be useful for the legal aspects of such cross-company agreements.

Design Mode Improvements

Recent feedback indicates that users struggle a bit with FieldAP as a design tool. There is therefore a clear benefit to explore future features in intelligent design.

One example is to offer an expansion on the design rule set e.g. if connection and sockets have more meta data assigned. A user is presented with more options when creating a connection e.g. by clicking a 6-inch oil connection to query if draw manually or connect to the following assets that fit the 6-inch socket characteristics. Adding certain design limitations such as bending restriction indicators is also be helpful.

Pipe Design Tool with Bending Restriction Rules

One example of this disclosure is a separate design module executable by a computer having a processor and memory having executable instructions, such as a server, for designing a pipe layout on a subsea floor using restriction rules. For example, the module enables a user to define the Minimum Bend Range (MBR) for a pipe connection (i.e. 1000 meters) and enables pipe layout designing on the subsea floor using the MBR in settings. When creating the spline, the user is forced to curve a pipe layout design on the given radius. After a curve, a piece of inline equipment, such as Inline-T or a connected structure, the user cannot create a curve on the first 500 meters out from the connection point. This can be a parameter such as step-out length. Some possible design characteristics/parameters can be, but not limited to:

User can enable MBR when doing pipe design.

User can choose to create a directional intermediate point (no bending), or curved point.

User can define the bend radius in the MBR tab.

User might be able to toggle the tangent (with circle) on curved points.

User can display the length on all intermediate points.

User can change a directional intermediate point to a curved one.

A new “Bending” module facilitates accelerated pipe design layouts once enabled that enforces user defined design restrictions such as “Bending radius” and “Bend length”. This is achieved by the display of a bend radius circles when a pipe or connection needs to have a bend as shown in FIG. 13. The pipe will then curve around the defined bend radius set in meters until it continues its path until the need for the next bend. The circles can also be freely positioned and moved around for design tweaking. For each such pipe design the system will remember all bend radius circles and will display them again when the pipe (connection) is selected so they can be further edited by the user.

Design features that are useful for this feature:

Being able to generate the spline by using ctrl to create the curved angle.

Be able to move all the curve points by clicking and moving the circles.

Be able to increase and decrease the radius on all curve points while drawing and maybe also after they have been drawn.

Be able to see the radius as text on all curved points.

Other use cases—Spud detection

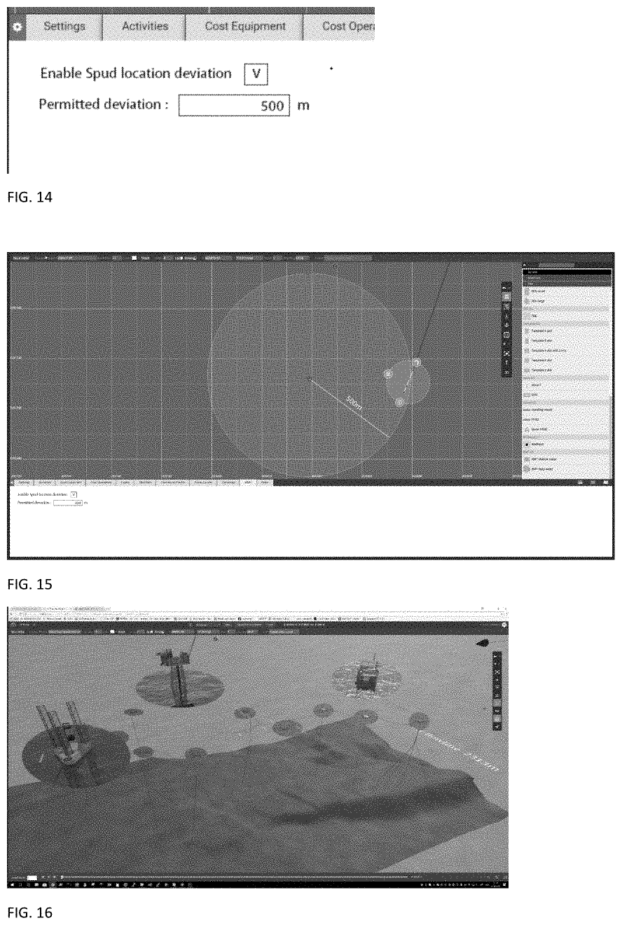

When users are routing pipelines, they are also interested in how far away from the target in the reservoir they can place the wells on the seabed. These can easily deviate from the target up to 500 meters. This makes a difference when tying to route the pipes since they need to use the bend restrictions. By detecting and displaying a circle around the wells(spuds) when the user has the mouse/asset within e.g. 500 m (deviation radius is user defined setting) from the target spot it allows the user easily to see how close they need to be from the target area., e.g. sample settings shown in FIG. 14.

When spud/target deviation detection is enabled it will then be based on the user's pipe layout position and when entering the deviation circle display like e.g. the illustration of FIG. 15.

We also need to state good minimum user HW requirements with respect to screen size, use mouse over trackpad, CPU/GPU recommendations and so forth.

Presentation and Reporting

Field Activity Planner has become a very popular presentation and reporting tool for many users or subset of users within the customer organizations today. It would therefore be useful to see how we can offer future improved benefits.

Improved Presentation View/Mode

Some design concepts we can explore would be functionality such as 3D scene view cut-throughs, or using multiple camera views to show topside, subsea, and sub terrain as shown in FIG. 16.

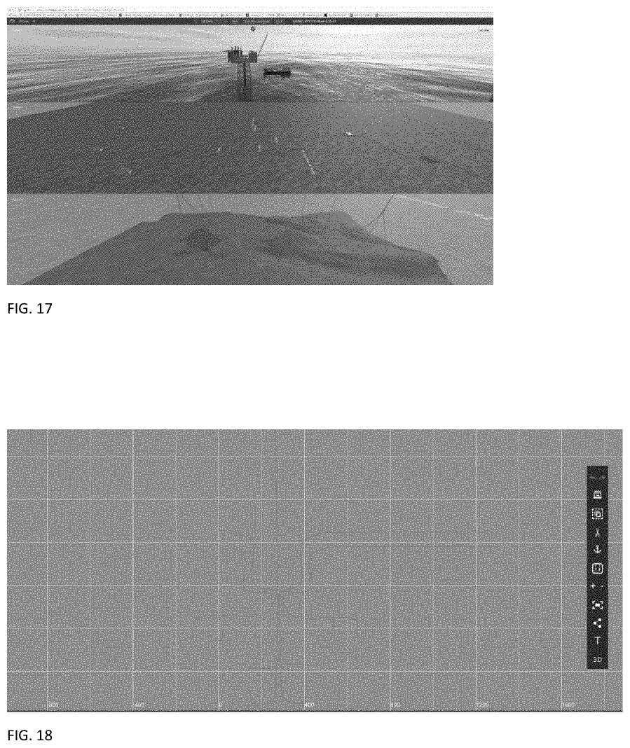

FIG. 17 shows an example of using multiple cameras.

Condensed/Clustered View

Most subsea fields are very large e.g. they can span several kilometers in any direction, and Field Activity Planner uses real world coordinates for asset placement, which when zooming out to encompass the entire screen makes any assets and connections(pipes) too small to see, as shown in FIG. 18. Users often wish the view the entire field layout on screen for discussions, presentations, and distribution to project members and stakeholders.

Therefore, they often try to make something in PowerPoint etc. FieldAP do support horizontal/vertical scale settings to scale up and down from real world coordinate layouts. However, this means that assets that are close to each other will be display on top of each other if they are nearby in real world terms.

It would therefore be beneficial to better achieve this functionality through development of a new clustering or condensed view algorithm.

A Cluster View or Condensed View feature for sub-projects would use a new algorithm that will contract all assets and pipes whilst observing size, dimension, and position relationships and contract the original field as far as possible while avoiding asset/connection clashes and overlaps and create a new field for this purpose. E.g. a new “Condensed” sub project is created for easy viewing.

This will downscale the entire field layout even for very large field layouts comprised of assets, pipelines etc. to fit the current view for easy project presentation and image export in both 2D and 3D view. The algorithm would also need to preserve the Z dimension (depth) relationship between topside (sea level) assets (platform, rigs, vessels) and the subsea assets (seabed), and also consider project data such as bathymetry and subsurface data (below seabed) such as well and reservoir data.

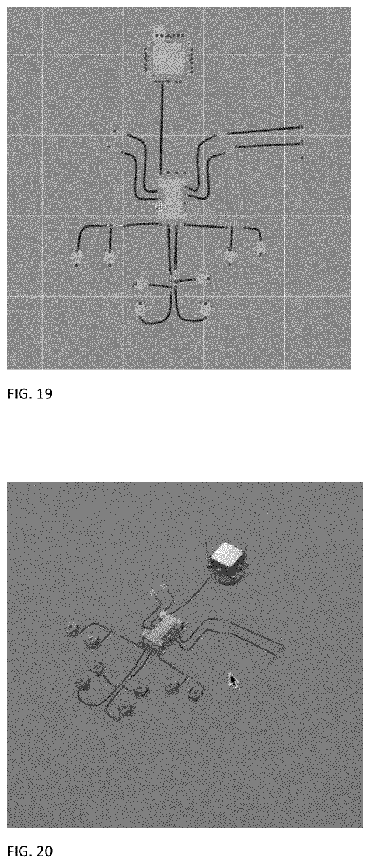

So after a condensed/cluster view algorithm is executed the user will be presented with a large field layout shown in contracted form as shown below in both 2D (FIGS. 19) and 3D view (FIG. 20) with no overlap on assets and preserving the original layout even in condensed form.

Engineering/Schematic View

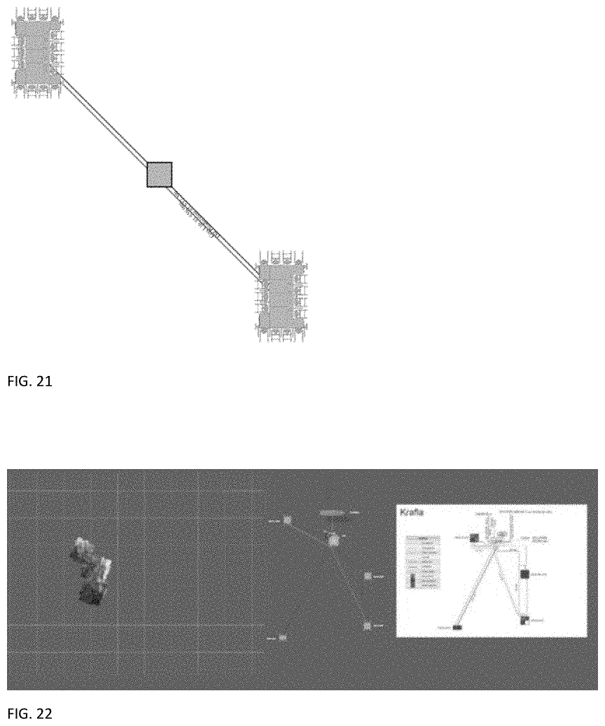

This is much requested feature as an overview of all assets/lines/Connections. The schematic in FIG. 21 is generated from our beta version at the moment.

This is in Beta at the moment, but we need to improve on it as this is constantly used in the early design phase by all our clients and is typically done in PPT or Visio today. And, unfortunately quite a few of the users have the view that if they can't do this then they do not see the real value of FieldAP with smart connections and associated metadata etc. A screenshot of a customer engineering design in white to the right and FieldAP approximation of the same engineering layout next to it is shown in FIG. 22.

P&ID View

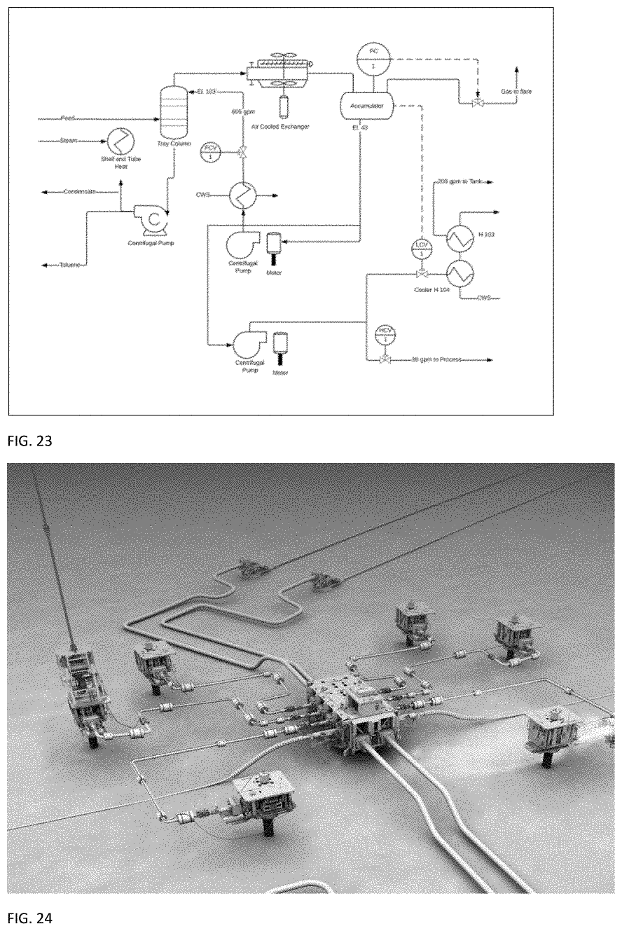

We constantly get requests for P&ID (Piping and Instrumentation) diagrams of assets or an internal routing view if you like, such as shown in FIG. 23. Users like to have this information readily available for their subsea layout design.

The P&ID's can be considered instrumentation flowcharts if you will, and we are considering OEM'ing this capability from LucidChart based on a review of the commercial and technical terms. The functionality would be to invoke their offering most likely in a white labeled form when a user double clicks on an asset. That would then present the associated P&ID or the opportunity to draw/edit one.

FPS Mode Improvements

Our users are very impressed with the “Fly by mode” feature we introduced. Improvements on this solution would be to add waypoints in a list that can be quickly jumped to for presentation purposes. And maybe accessed by hitting a keyboard shortcut such as “W” that goes from one viewpoint to the next when users present a field design.

Other scenarios would be to record the camera route that could even be distributed to other users or be part of the project for playback. Combined with the feature below we can also envision a server-side video rendering of the route to be used as a video presentation.

Server-Side Rendering

If we considered that our 3D assets could have matching server-side representations with assigned materials and higher poly counts/detail levels and we have a descriptive/matching scene graph it could be a nice feature if users zoom in on a specific area/view. Then select a “High rendition” option that would generate a server-side rendition of the same scene and a high res screen shot would be made available for download by a notification in FieldAP when ready as shown in FIG. 24. This would possibly allow for the use of lighting, reflection and materials for a glossier presentation output, and could also be included in a generate report output.

Report Generator

With a complete use of Field AP e.g. adding required meta data, assigning cost, field layout with correct positions/distances, addons such as flow assurance etc. you typically have all the information required that would comprise a tender. It would therefore be useful to have a generate report feature that would output the data as a report they could use to quickly finalize their bidding/tenders. We can probably work with OSS on this, but envision a PDF that have images of the field layouts, tables with MEL, cost overview comprised of CAPEX, OPEX, DRILLEX etc. Include data from the new Statistics module etc.

3D globe support

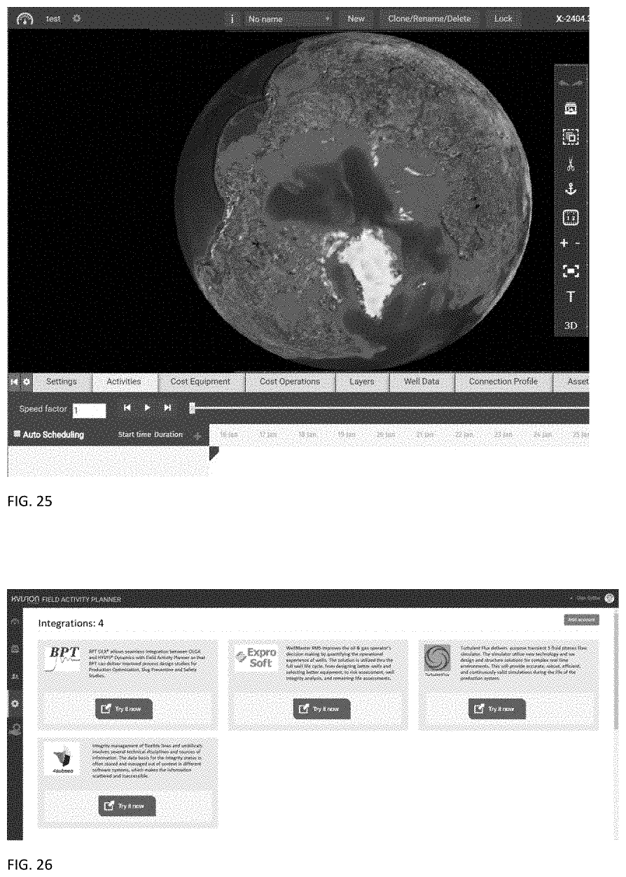

Based on previous experience we can with the introduction of tiling support allow for a 3D view of the globe as a Google Earth representation as shown in FIG. 25. Probably most useful with respect to an operational overview, but with provide an impressive showing of our GIS/Map related capabilities.

For land-based facility planning DEM data from NASA satellite coverage would also be available by default and probably be sufficient for early phase layouts. An agreement with providers such as TCarta could provide bathymetry data on a more global scale as well.

IoT/Sensors

This will primarily be partner driven, but from a sales and positioning perspective it would be useful to have a sample implementation with a dataset running. We can leverage Google Cloud https://cloud.google.com/solution/iotv or Azure IoT suite https://www.microsoft.com/nb-no/internet-of-things/azure-iot-suite. The key would be to have a sample demo that consume live IoT sensor data e.g. or playback of the data stream.

Simulations/Analytics/Calculations as a Service

To leverage our generic, neutral and independent platform stack we have the opportunity with our open API and promoted open standards to attract other vendors that would like to provide simulations-, analytics-, or calculations-as-a-service. This could be pipe simulations, flow assurance, drill planning, riser calculations etc. It could also be IoT data.

By providing them in-app-solution marketplace so that they gain exposure and allow our customers to try their solutions with the field layouts is an obvious mutual benefit and will attract more partners to our eco-system. Potential partners here can be BPT, 4Subsea, TurbulentFlux, Pro Well Plan, Costsystems.eu and others. An example is an UI integration shown in FIG. 26.

Cost Server Integration

Today we provide a basic cost server interface with rudimentary integration tools e.g. source code and documentation for developers. As cost calculations on Field Development Layouts are key to most of our client base in the EPC segment the ability for them to interface their cost data with FieldAP is therefore key. Our experience so far indicates that most cost databases are big Excel spreadsheets or similar in-house solutions.

Given our resource restrains we need to adapt an approach that allows to provide a basic starting point e.g. better Excel sample, and also provide maybe a set of cost system connectors to the biggest systems such as Omega PIMS, SAP, and also Cleopatra Enterprise, which we have a dialogue with.

Expand statistics dashboard with capex, opex, drillex stats

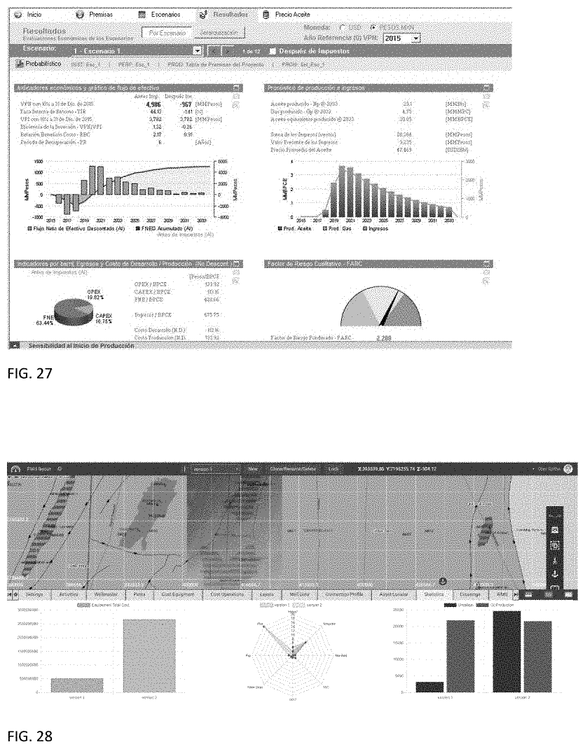

If we look at what we would deem direct competitors to our system they typically highlight the economics of potential Field Developments and compare various alternatives based on KPI's such as Capex, Opex and NPV calculations etc. A Cayros C-Field presents this as their stats dashboard as shown in FIG. 27.

There is therefore value to present relevant comparative indicators in our new Statistics Dashboard module highlighting e.g. NPV calculations and provide CAPEX, OPEX information as shown in FIG. 28.

CMS System Integration

As we hopefully become the visual information platform or hub if you will—where we visualize data in context from the various data sources within a company we know from experience that finding the right information quickly becomes challenging.

Many companies employ Document Management or Content Management systems, but that is typically driven as just a collection of content and not seen in relationship with a visual Field Development. E.g. documents just become documents that must be searched by name, or PID (product-id) references in SAP as one example.

Forrester Group research indicates that as much as 62-73% of data a corporation has is not used for decision making purposes.

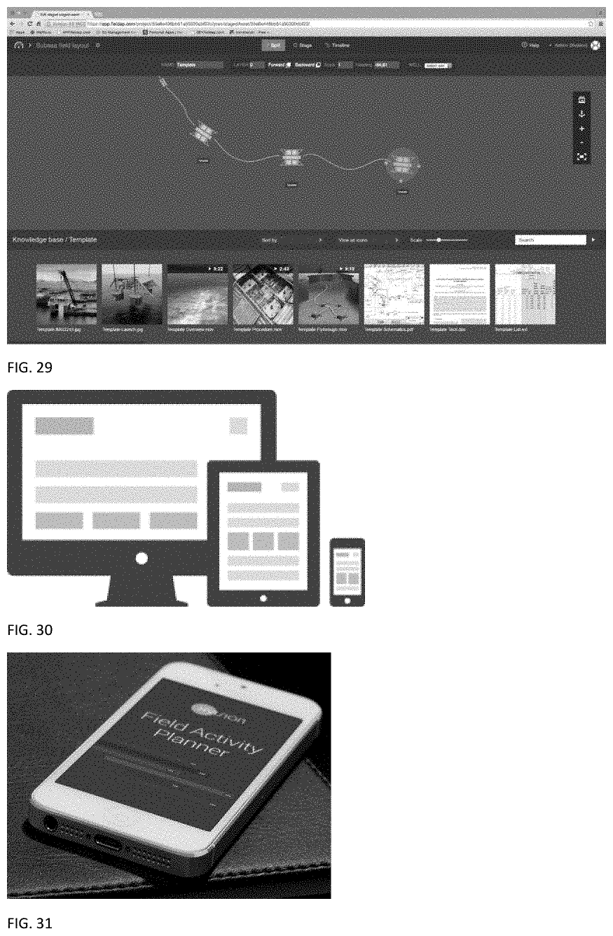

There would therefore be value to link documents, drawings, images, videos with respect to our “DAIM model”. We could envision e.g. an integration with MS SharePoint and for instance tie in the DVELVE search so when a user clicks on an asset in is presented visually as shown in FIG. 29. As a younger generation enters the workforce that has been taught to be visual from an early age e.g. Netflix and Spotify we know from experience that visual context based search and navigation is extremely effective.

Mobile App

As the software also becomes a more involved in the operation phase e.g. a planned marine operation/installation with Field Activity Planner it will be a clear benefit to have a mobile client that can give a project manager a quick up to date glance on the daily status of activities and other relevant operational data. By employing a liquid screen design principle, a mobile client will therefor present only informational views adapted to the screen that is used as shown in FIG. 30.

Based on screen size only relevant content is then displayed in the context of a smaller screen such as on a smaller device maybe only the topline of the project plan needs to be displayed, or maybe a list of assets with the most important sensors reading attached. A tablet size screen would support layout viewing, but probably not editing of the layout as shown in FIG. 31.

Machine Learning

As the system is used more and more over time we accumulate and store project relevant data from our users; layout, cost, asset use and configuration, meta data, project planning information, marine operations etc. This opens for possible use cases where we can process all this collected data and potentially apply machine learning.

Machine learning could be used with weather forecasting, combined with historical wind and wave hindcast data from Ocean4Cast and thus do operational planning forecasting for FieldAP marine installations e.g. activity planning.

If previous marine operations have been done within Fieldap the experience data from that would also be another data source.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

We claim:

1. An oil & gas pipe layout design module configured to enable a user to determine a layout of pipe based on minimum bend range, design circles, and locations of drilling assets on a subsea floor.
